(19) United States
(12) Patent Application Publication
(10) Pub. No.: US 2019/0394377 A1
(43) Pub. Date: Dec. 26, 2019

(54) INFORMATION PROCESSING DEVICE, IMAGE CAPTURING DEVICE, AND ELECTRONIC APPARATUS

(71) Applicant: SONY SEMICONDUCTOR SOLUTIONS CORPORATION, KANAGAWA (JP)

(72) Inventors: MASAFUMI ZAMA, KANAGAWA (JP); KENYA MICHISHITA, CHIBA (JP); KATSUMI KATOU, TOKYO (JP); DAISUKE KOYANAGI, KANAGAWA (JP)

(21) Appl. No.: 16/478,199

(22) PCT Filed: Jan. 29, 2018
(86) PCT No.: PCT/JP2018/002608

§ 371 Date: Jul. 16, 2019

(30) Foreign Application Priority Data
Mar. 14, 2017 (JP) 2017-048761

(51) Int. Cl. H04N 5/235; G03B 7/091

(52) U.S. Cl. CPC H04N 5/2351; G03B 7/091; H04N 5/2353

(57) ABSTRACT

[Object] It is desired to provide a technology capable of appropriately controlling brightness of images by using a simpler structure. [Solving Means] Provided is an information processing device including: a determination unit that determines a range of brightness on a basis of a plurality of pieces of imaging data captured by a plurality of image capturing units; and an exposure control unit that controls exposure values of the plurality of image capturing units on a basis of the range of brightness.

### TECHNICAL FIELD

The present disclosure relates to an information processing device, an image capturing device, and an electronic apparatus.

### BACKGROUND ART

In recent years, a technology of controlling an exposure value of a camera (hereinafter, also referred to as “exposure control”) in a manner that brightness of an image captured by the camera becomes desired brightness, has been developed. According to such a technology, in the case where a brightness range of a subject is wider than a predetermined range, sometimes a state such as blown-out highlights or the like (saturation) arises in an image. Therefore, there is a technology of expanding a dynamic range to suppress a possibility that such a state arises (for example, Patent Literature 1).

### CITATION LIST

### Patent Literature

Patent Literature 1: JP 2010-074618A

### DISCLOSURE OF INVENTION

### Technical Problem

However, in general, a dedicated image sensor and a dedicated signal processing circuit are necessary for the technology of expanding the dynamic range. For example, such a technology needs a plurality of image sensors with different exposure values and a circuit that combines respective images captured by the plurality of image sensors. Therefore, it is desired to provide a technology capable of appropriately controlling brightness of the images by using a simpler structure.

### Solution to Problem

According to the present disclosure, there is provided an information processing device including: a determination unit that determines a range of brightness on a basis of a plurality of pieces of imaging data captured by a plurality of image capturing units; and an exposure control unit that controls exposure values of the plurality of image capturing units on a basis of the range of brightness.

According to the present disclosure, there is provided an image capturing device including: a plurality of image capturing units; a determination unit that determines a range of brightness on a basis of a plurality of pieces of imaging data captured by the plurality of image capturing units; and an exposure control unit that controls exposure values of the plurality of image capturing units on a basis of the range of brightness.

According to the present disclosure, there is provided an electronic apparatus including: a determination unit that determines a range of brightness on a basis of a plurality of pieces of imaging data captured by a plurality of image capturing units; an exposure control unit that controls exposure values of the plurality of image capturing units on a basis of the range of brightness; and a display unit that performs display based on at least any one of a plurality of pieces of imaging data captured by the plurality of image capturing units after controlling the exposure values.

### Advantageous Effects of Invention

As described above, according to the present disclosure, there is provided a technology capable of appropriately controlling brightness of images by using a simpler structure. Note that the effects described above are not necessarily limitative. With or in the place of the above effects, there may be achieved any of the effects described in this specification or other effects that may be grasped from this specification.

### BRIEF DESCRIPTION OF DRAWINGS

FIG. 1 is a diagram illustrating a configuration example of a general camera system for image recognition.

FIG. 2 is a block diagram illustrating a functional configuration example of an information processing device according to the embodiment.

FIG. 3 is a diagram for describing a detailed function of a detection unit.

FIG. 4 is a diagram illustrating an example of regions included in imaging data.

FIG. 5 is a diagram for describing a detailed function of an exposure control unit.

FIG. 6 is a diagram for describing a detailed function of the exposure control unit.

FIG. 7 is a diagram illustrating an example of evaluation values after controlling different exposure values.

FIG. 8 is a diagram illustrating respective specific examples of a brightness calculation result and imaging data corresponding to a first example illustrated in FIG. 7.

FIG. 9 is a diagram illustrating respective specific examples of a brightness calculation result and imaging data corresponding to a second example illustrated in FIG. 7.

FIG. 10 is a diagram illustrating a luminance histogram in a detection region.

FIG. 11 is a diagram for describing an example in which a lower limit value is set for an evaluation value.

FIG. 12 is a diagram illustrating images and luminance histograms before and after performing gradation conversion.

FIG. 13 is a block diagram illustrating an example of a hardware configuration of the information processing device according to the embodiment.

### MODE(S) FOR CARRYING OUT THE INVENTION

Hereinafter, (a) suitable embodiment(s) of the present disclosure will be described in detail with reference to the appended drawings. Note that, in the specification and the drawings, structural elements having substantially the same function or configuration are denoted by the same reference signs, and redundant description thereof will be omitted.

In addition, in this specification and the drawings, structural elements that have substantially the same or similar function or configuration are sometimes distinguished from each other by attaching different numerals after the same reference signs. However, when there is no need in particular to distinguish structural elements that have substantially the same or similar function or configuration, the same reference sign alone is attached. In addition, similar structural elements according to different embodiments are sometimes distinguished from each other by attaching different alphabets after the same reference signs. However, when there is no need in particular to distinguish such similar structural elements, the same reference sign alone is attached.

Note that, the description is given in the following order.

### 0. Overview

### 1. Embodiment of Present Disclosure

### 1.1. Functional Configuration Example of Information Processing Device

### 1.2. Details of Functions of Information Processing Device

### 1.2.1 Details of Functions of Detection Unit

### 1.2.2. Details of Functions of Range Determination Unit

### 1.2.3. Details of Functions of Exposure Control Unit

### 1.2.4. Details of Functions of Other Configurations

### 1.2.5. Various Kinds of Modifications

### 1.3. Hardware Configuration Example

### 2. Conclusion

### 0. Overview

In recent years, a technology of controlling an exposure value of a camera (hereinafter, also referred to as “exposure control”) in a manner that brightness of an image captured by the camera becomes desired brightness, has been developed. According to the technology, in the case where a brightness range of a subject is wider than a predetermined range, sometimes a state such as blown-out highlights or the like (saturation) arises in an image. Therefore, there is a technology of expanding a dynamic range to suppress a possibility that such a state arises.

However, in general, a dedicated image sensor and a dedicated signal processing circuit are necessary for the technology of expanding the dynamic range. For example, such a technology needs a plurality of image sensors with different exposure values and a circuit that combines respective images captured by the plurality of image sensors. In addition, it is also necessary to adjust gradation levels between a plurality of cameras. As an example of the technology, a general camera system for image recognition will be described.

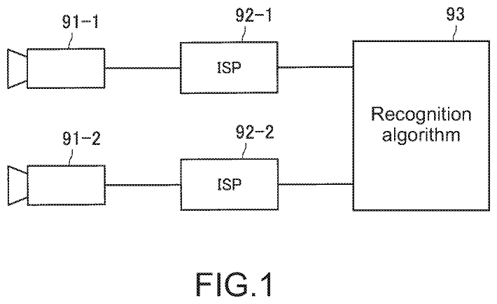

FIG. 1 is a diagram illustrating a configuration example of the general camera system for image recognition. As illustrated in FIG. 1, the general camera system for image recognition includes an image capturing unit 91-1, an image capturing unit 91-2, image signal processing (ISP) 92-1, ISP 92-2, and a recognition algorithm 93. The image capturing unit 91-1 and the image capturing unit 91-2 have different exposure values from each other.

The ISP 92-1 performs a signal process on an image captured by the image capturing unit 91-1, and the image is output to the recognition algorithm 93. In a similar way, the ISP 92-2 performs a signal process on an image captured by the image capturing unit 91-2, and the image is output to the recognition algorithm 93. For example, in the case where operation is performed by using an operation body (such as a hand), the recognition algorithm 93 recognizes the operation body on the basis of the image output from the ISP 92-1 and the image output from the ISP 92-2.

At this time, to cause the recognition algorithm 93 to recognize the operation body from the image, it is better to prevent saturation in a region including the image of the operation body (region of interest) and it is better to prevent blocked-up shadows in the region of interest. Here, to appropriately control the exposure values, sensing is necessary for determining brightness of the region of interest with the controlled exposure values. Therefore, a feedback loop will occur (repetition of controlling of the exposure values and sensing), and it is considered that the system will become unstable.

Accordingly, it is considered that a dynamic range is expanded by combining the image output from the ISP 92-1 and the image output from the ISP 92-2. However, as described above, a dedicated image sensor and a dedicated signal processing circuit are necessary for the technology of expanding the dynamic range. Note that, it is not necessary to recognize the operation body from an image. It is only necessary to generate an image that is easily viewable for a user as long as the user simply sees the image.

In this specification, the technology capable of appropriately controlling brightness of an image by using a simpler structure will be mainly described. For example, in this specification, a plurality of image sensors with different exposure values or a circuit for combining images captured by the respective image sensors is not necessary. The description will be given with regard to the technology of controlling exposure values in accordance with a brightness range of an image in a manner that a state such as blown-out highlights or the like (saturation) does not arise in the image and in a manner that the image has standard brightness.

The overview of the embodiment of the present disclosure has been described above.

### 1. Embodiment of Present Disclosure

### 1.1. Functional Configuration Example of Information Processing Device

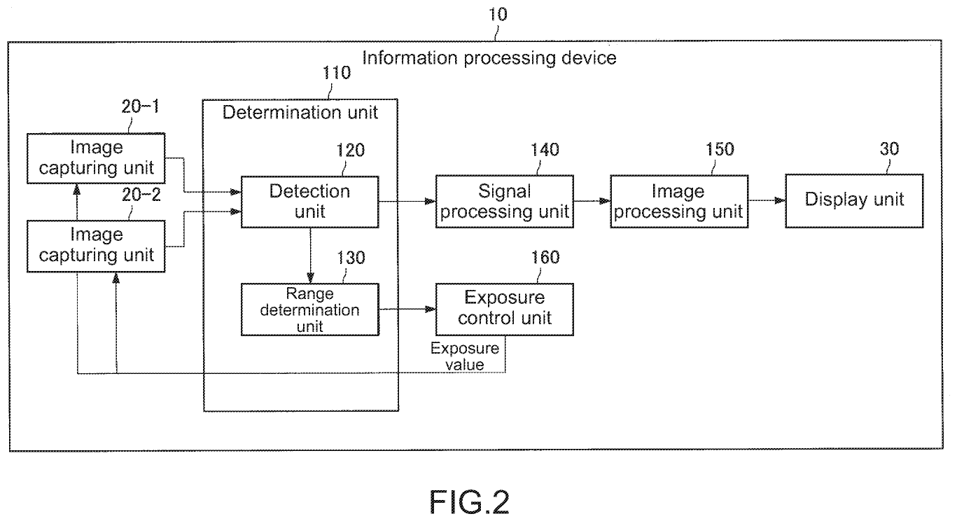

Next, a functional configuration example of an information processing device according to the embodiment of the present disclosure will be described. FIG. 2 is a block diagram illustrating the functional configuration example of the information processing device according to the embodiment of the present disclosure. As illustrated in FIG. 2, an information processing device 10 includes an image capturing unit 20-1, an image capturing unit 20-2, a determination unit 110, a signal processing unit 140, an image processing unit 150, an exposure control unit 160, and a display unit 30. The determination unit 110 includes a detection unit 120 and a range determination unit 130. Next, these functional blocks included in the information processing device 10 will be described.

Note that, the information processing device 10 according to the embodiment of the present disclosure may be applied to various kinds of electronic apparatuses. For example, the electronic apparatus to which the information processing device 10 is applied may be a smartphone, a mobile phone, a tablet terminal, or a head-mounted display. Alternatively, the electronic apparatus to which the information processing device 10 is applied may be an image capturing device. The image capturing device may be a digital camera, an on-board camera that is installed on a vehicle, or the like.

The image capturing unit 20-1 includes an image sensor, and captures an image on the basis of a preset exposure value. In addition, the image capturing unit 20-1 captures an image on the basis of an exposure value controlled by the exposure control unit 160. In a way similar to the image capturing unit 20-1, the image capturing unit 20-2 also includes an image sensor, and captures an image on the basis of a preset exposure value. In addition, in a way similar to the image capturing unit 20-1, the image capturing unit 20-2 captures an image on the basis of an exposure value controlled by the exposure control unit 160.

According to the embodiment of the present disclosure, the exposure value of the image capturing unit 20-1 and the exposure value of the image capturing unit 20-2 may be a same value. In other words, the exposure value may be common to the image capturing unit 20-1 and the image capturing unit 20-2.

Note that, according to the embodiment of the present disclosure, a case where the image capturing unit 20-1 and the image capturing unit 20-2 are included in the information processing device 10 is mainly considered. However, it is also possible that the image capturing unit 20-1 and the image capturing unit 20-2 are outside of the information processing device 10. In addition, according to the embodiment of the present disclosure, a case where the number of image capturing units 20 is two is mainly considered. However, the number of image capturing units 20 is not limited as long as the number is two or more. For example, the number of image capturing units 20 may be three or more.

The determination unit 110, the signal processing unit 140, the image processing unit 150, and the exposure control unit 160 may be implemented by a processing device such as one or a plurality of central processing units (CPUs) or the like. In the case where such blocks are implemented by a processing device such as the CPU, such a processing device may be implemented by an electronic circuit. Details of these blocks will be described later.

The display unit 30 outputs various kinds of information. For example, the display unit 30 may include a display capable of performing display that is visually recognizable for users. In this case, the display may be a liquid crystal display, or an organic electro-luminescence (EL) display. Note that, according to the embodiment of the present disclosure, a case where the display unit 30 is included in the information processing device 10 is mainly considered. However, it is also possible that the display unit 30 is outside of the information processing device 10.

The functional configuration example of the information processing device 10 according to the embodiment of the present disclosure has been described above.

### 1.2. Details of Functions of Information Processing Device

Next, details of functions of the information processing device 10 according to the embodiment of the present disclosure will be described.

According to the embodiment of the present disclosure, the determination unit 110 determines a range of brightness on the basis of imaging data captured by the image capturing unit 20-1 and imaging data captured by the image capturing unit 20-2. Next, the exposure control unit 160 controls exposure values of the image capturing unit 20-1 and the image capturing unit 20-2 on the basis of the range of brightness determined by the determination unit 110. By using the above-described configurations, it is possible to appropriately control brightness of an image by using a simpler structure.

### 1.2.1 Details of Functions of Detection Unit

As described above, the determination unit 110 includes the detection unit 120 and the range determination unit 130. First, details of functions of the detection unit 120 will be described.

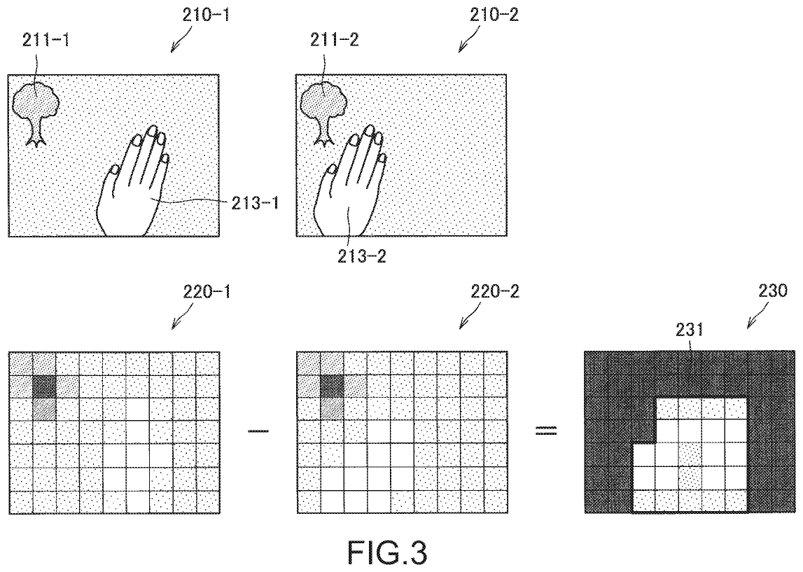

FIG. 3 is a diagram for describing the details of the functions of the detection unit 120. FIG. 3 illustrates imaging data 210-1 captured by the image capturing unit 20-1. The imaging data 210-1 includes an image of a subject (hereinafter, also referred to as a “far-distant object”) 211-1 that is more than a predetermined distance away from the image capturing unit 20-1. In addition, the imaging data 210-1 includes an image of a subject (hereinafter, also referred to as a “near-distant object”) 213-1 that is close to the image capturing unit 20-1 within the predetermined distance.

In addition, FIG. 3 illustrates imaging data 210-2 captured by the image capturing unit 20-2. The imaging data 210-2 includes an image of a subject (hereinafter, also referred to as a “far-distant object”) 211-2 that is more than the predetermined distance away from the image capturing unit 20-2. In addition, the imaging data 210-2 includes an image of a subject (hereinafter, also referred to as a “near-distant object”) 213-2 that is close to the image capturing unit 20-2 within the predetermined distance.

The far-distant object 211-1 and the far-distant object 211-2 are the same subject, and they are more than the predetermined distance away from the respective image capturing units 20-1 and 20-2. Therefore, the position of the far-distant object 211-1 in the imaging data 210-1 is substantially the same as the position of the far-distant object 211-2 in the imaging data 210-2. On the other hand, the near-distant object 213-1 and the near-distant object 213-2 are the same subject, and they are close to the respective image capturing units 20-1 and 20-2 within the predetermined distance. Therefore, there is a gap between the position of the near-distant object 213-1 in the imaging data 210-1 and the position of the near-distant object 213-2 in the imaging data 210-2.

Accordingly, the detection unit 120 calculates brightness of the respective regions in the imaging data 210-1 and the imaging data 210-2. Next, the detection unit 120 detects a detection region on the basis of the brightness of the respective regions in the imaging data 210-1 and the imaging data 210-2.

In the present specification, a case where the detection unit 120 detects a subject region (hereinafter, also referred to as a “near-distant region”) as the detection region will be mainly considered. The subject region is closer to the image capturing unit 20-1 and the image capturing unit 20-2 within the predetermined distance. Accordingly, it is possible to appropriately control exposure of the near-distant region (such as a region including an image of the operation body like a hand, for example). In addition, it is possible to improve recognition accuracy of the operation body since the exposure of the near-distant region is appropriately controlled. However, it is also possible for the detection unit 120 to detect a subject region (hereinafter, also referred to as a “far-distant region”) as the detection region. The subject region is more than a predetermined distance away from the image capturing unit 20-1 and the image capturing unit 20-2.

For example, in the case where the information processing device 10 is the on-board camera or the like, it is desired to more appropriately control exposure of scenery (such as a building, for example) that is more than a predetermined distance away from the on-board camera, in comparison with a road surface that is closer to the on-board camera within the predetermined distance. Therefore, in the case where the information processing device 10 is the on-board camera or the like, it is possible for the detection unit 120 to detect the far-distant region as the detection region. Alternatively, in the case where a user is moving (for example, in the case where the user is walking), it is possible for the detection unit 120 to detect the far-distant region as the detection region for a similar reason.

FIG. 3 illustrates a brightness calculation result 220-1 with regard to regions of the imaging data 210-1. In addition, FIG. 3 illustrates a brightness calculation result 220-2 with regard to regions of the imaging data 210-2. With reference to the brightness calculation result 220-1 and the brightness calculation result 220-2, colors become darker as the regions get darker. For example, as brightness of the respective regions in the imaging data 210-1 and the imaging data 210-2, it is only necessary for the detection unit 120 to calculate an integrated value or an average value of brightness of respective regions of the imaging data 210-1 and the imaging data 210-2.

Note that, according to the embodiment of the present disclosure, a case where a plurality of pixels are included in a single region is mainly considered. However, it is also possible for the region to include only one pixel. In this case, it is only necessary for the detection unit 120 to treat brightness of the respective pixels in the imaging data 210-1 and the imaging data 210-2, as brightness of respective regions of the imaging data 210-1 and the imaging data 210-2.

The specific method of detecting the detection region is not specifically limited. For example, the detection unit 120 may calculate a difference value of brightness in corresponding regions in the imaging data 210-1 and the imaging data 210-2, and detect the detection region on the basis of a relation between the difference value and a predetermined reference value. For example, the predetermined reference value may be set in advance. The predetermined reference value may be changed appropriately through user operation.

For example, the regions with the difference value of brightness that exceeds the predetermined reference value are considered to be the near-distant regions because there is a gap between the imaging data 210-1 and the imaging data 210-2 with regard to the positions of the same subject. Therefore, the detection unit 120 may detect the regions with the difference value of brightness that exceeds the predetermined reference value, as the detection regions (near-distant regions).

Note that, FIG. 3 illustrates a difference image 230 in which difference values of brightness are calculated for respective regions. In the difference image 230, the regions have lighter colors as the difference values of brightness increase. Here, for example, sometimes a difference value of brightness does not exceed the predetermined reference value with regard to a region surrounded by regions with the difference values of brightness that exceed the predetermined reference value (in other words, white regions in the difference image 230), although the region include an image of the near-distant object.

Therefore, the detection unit 120 may detect, as a detection region 231 (near-distant region), a region (such as a region surrounded by regions with difference values of brightness that exceed the predetermined reference value other than the regions) including the region with the difference values of brightness that exceed the predetermined reference value (in other words, white region in the difference image 230).

In addition, as described above, the detection unit 120 may detect the far-distant region as a detection region. In such a case, it is also possible for the detection unit 120 to detect the region with the difference value of brightness that does not exceed the predetermined reference value, as the detection region (far-distance region). Alternatively, in a way similar to detection of the near-distant region, the detection unit 120 may detect a region including a region with a difference value of brightness that does not exceeds the predetermined reference value, as the detection region (far-distant region).

The details of functions of the detection unit 120 have been described above.

### 1.2.2. Details of Functions of Range Determination Unit

Next, details of functions of the range determination unit 130 will be described. The range determination unit 130 determines a range of brightness on the basis of the maximum value of brightness in the detection region 231 and a representative value of brightness in a predetermined region including the detection region 231. Here, the range determination unit 130 may use any of brightness of the imaging data 210-1 and brightness of the imaging data 210-2, for the determination. Next, an example in which the range determination unit 130 uses the imaging data 210-1 for determination will be mainly described. However, it is also possible for the range determination unit 130 to use the imaging data 210-2 for the determination.

In addition, hereinafter, a case where the predetermined region including the detection region 231 is a region including the detection region 231 and another region (specifically, the all regions of the imaging data 210-1) will be mainly described. However, the predetermined region including the detection region 231 may be the detection region 231. In addition, hereinafter, a case where the range determination unit 130 calculates an average value of brightness in the predetermined region as the representative value will be mainly described. However, it is also possible for the range determination unit 130 to calculate the minimum value of brightness in the predetermined region as the representative value.

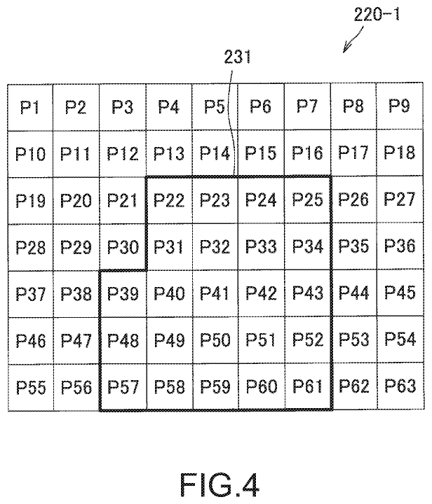

FIG. 4 is a diagram illustrating an example of regions included in the imaging data 210-1. As illustrated in FIG. 4, the imaging data 210-1 includes regions P1 to P63. For example, the range determination unit 130 determines brightness of the region P22 as the maximum value in the case where the brightness of the region P22 is the maximum value among the regions included in the detection region 231. In addition, the range determination unit 130 calculates an average value of brightness in all the regions of the imaging data 210-1, as a representative value.

Note that, the average value of brightness in all the regions of the imaging data 210-1 may be calculated after weighting brightness of the respective regions P1 to P63. At this time, for example, it is expected that an important subject appears in the center of the imaging data 210-1 rather than a side of the imaging data 210-1. Therefore, the weight of brightness is larger in the center of the imaging data 210-1 in comparison with the side of the imaging data 210-1. Alternatively, in the case where the information processing device 10 is the on-board camera or the like, it is expected that an important subject appears in the bottom of the imaging data 210-1 rather than the top of the imaging data 210-1. Therefore, the weight of brightness is larger in the bottom of the imaging data 210-1 in comparison with the top of the imaging data 210-1.

In the following description, sometimes an “evaluation value A” represents an average value of brightness in all the regions of the imaging data 210-1, and an “evaluation value B” represents the maximum value of brightness in the detection region 231 of the imaging data 210-1. Here, the range of brightness may be determined in any way while using the evaluation value A and the evaluation value B. For example, the range determination unit 130 may determine the range of brightness on the basis of a ratio of the evaluation value B to the evaluation value A. For example, the range determination unit 130 may determine the range of brightness on the basis of a mathematical expression 1.

Range of Brightness=20×log₁₀ (Evaluation Value B/Evaluation Value A) [dB] (Mathematical Expression 1)

Note that, the mathematical expression 1 is a mere example of a mathematical expression used for determining the range of brightness. Therefore, the mathematical expression used for determining the range of brightness is not limited to the above-described mathematical expression 1. For example, the constants in the mathematical expression 1 (such as a constant multiplied by the logarithm or a base of the logarithm) are not limited to the values in the mathematical expression 1.

The details of the functions of the range determination unit 130 have been described above.

### 1.2.3. Details of Functions of Exposure Control Unit

Next, details of functions of the exposure control unit 160 will be described. As described above, the exposure control unit 160 controls exposure values of the image capturing unit 20-1 and the image capturing unit 20-2 on the basis of the range of brightness determined by the range determination unit 130. Note that, in the following description, sometimes the range of brightness may be referred to as a “brightness range of a subject”.

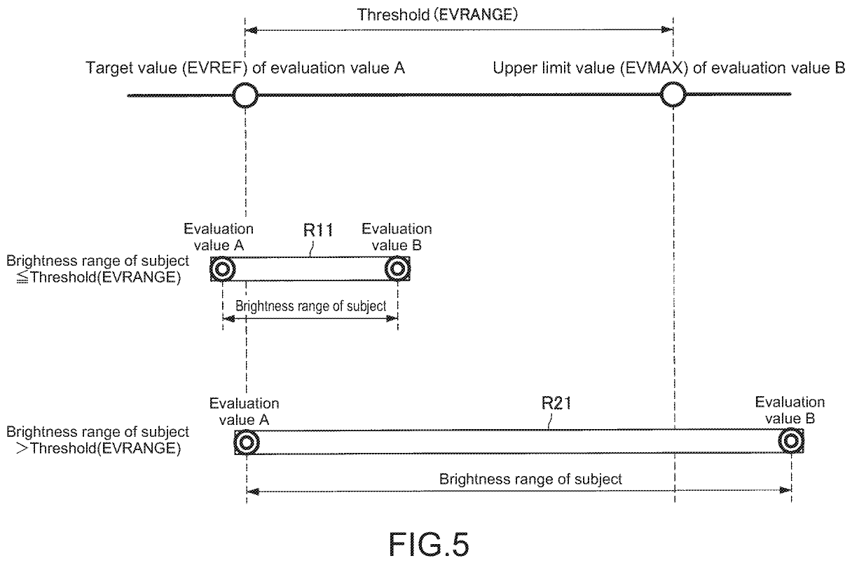

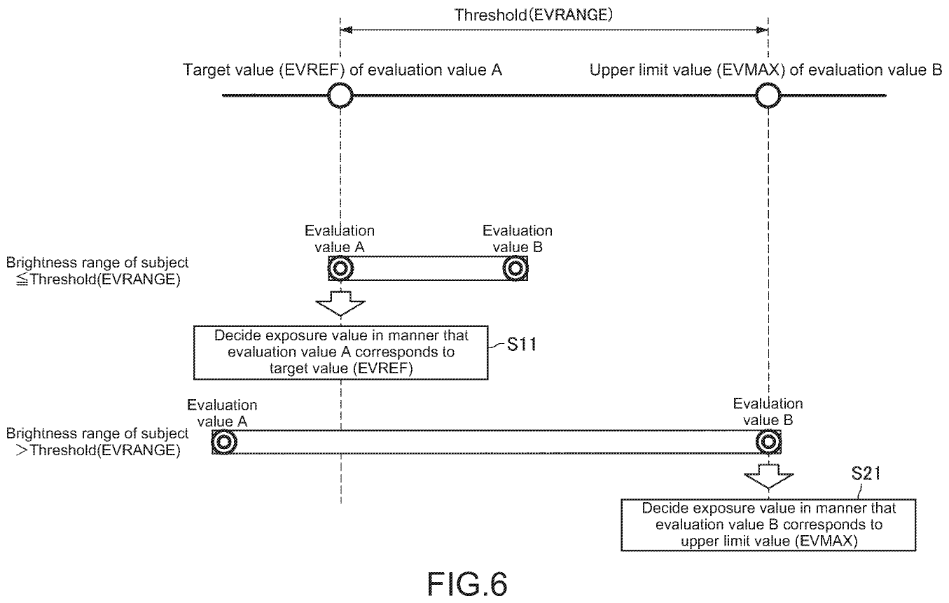

FIG. 5 and FIG. 6 are diagrams for describing details of functions of the exposure control unit 160. Specifically, FIG. 5 illustrates an example of the evaluation value A and the evaluation value B before exposure control. In addition, FIG. 6 illustrates an example of the evaluation value A and the evaluation value B after the exposure control.

As illustrated in FIG. 5, a threshold to be compared with a brightness range of a subject (hereinafter, also referred to as “EVRANGE”) is set in advance. In addition, as illustrated in FIG. 5, a target value of the evaluation value A (hereinafter, also referred to as “EVREF”) and an upper limit value of the evaluation value B (hereinafter, also referred to as “EVMAX”) are set in advance. Note that, the threshold, the target value of the evaluation value A, the upper limit value of the evaluation value B, and the like may be changed appropriately through operation performed by a user.

First, the exposure control unit 160 determines whether or not the brightness range of the subject exceeds the threshold (EVRANGE). Next, in the case where a brightness range R11 of the subject does not exceed the threshold (EVRANGE) (in the case where “the brightness range of the subject≤the threshold (EVRANGE) in FIG. 5), the exposure control unit 160 changes the exposure value in a manner that the evaluation value A corresponds to the target value (EVREF) of the evaluation value A. Accordingly, it is possible to control the exposure value in a manner that the imaging data has standard brightness.

FIG. 6 illustrates an example in which the exposure control unit 160 decides the exposure value in a manner that the evaluation value A corresponds to the target value (EVREF) (Step S11), and controls the exposure values of the image capturing unit 20-1 and the image capturing unit 20-2 on the basis of the decided exposure value, in the case where “the brightness range of the subject≤the threshold (EVRANGE)”. FIG. 6 also illustrates that, after the exposure control unit 160 controls the exposure values, the evaluation value A after controlling the exposure value corresponds to the target value (EVREF) of the evaluation value A.

On the other hand, in the case where a brightness range R21 of the subject exceeds the threshold (EVRANGE) (in the case where “the brightness range of the subject>the threshold (EVRANGE) in FIG. 5”), the exposure control unit 160 changes the exposure value in a manner that the evaluation value B corresponds to an upper limit value (EVMAX) of the evaluation value B. Accordingly, it is possible to control the exposure value in a manner that a state such as blown-out highlights or the like (saturation state) does not arise in the imaging data.

FIG. 6 illustrates an example in which the exposure control unit 160 decides the exposure value in a manner that the evaluation value B corresponds to the upper limit value (EVMAX) (Step S12), and controls the exposure values of the image capturing unit 20-1 and the image capturing unit 20-2 on the basis of the decided exposure value, in the case where “the brightness range of the subject>the threshold (EVRANGE)”. FIG. 6 also illustrates that, after the exposure control unit 160 controls the exposure values, the evaluation value B after controlling the exposure value corresponds to the target value (EVREF) of the evaluation value B.

Note that, in the examples illustrated in FIG. 5 and FIG. 6, the case where the number of thresholds to be compared with the brightness range of the subject is only one has been considered (a first threshold and a second threshold are the same value). Therefore, the exposure values are always changed regardless of whether or not the brightness range of the subject exceeds the threshold. However, there may be a case where the exposure values are not changed. For example, with regard to the brightness range of the subject, chattering may be removed or hysteresis may be applied to change in the exposure values.

For example, the first threshold is preliminarily set to be a value larger than the second threshold. In the case where the brightness range of the subject exceeds the first threshold, the exposure control unit 160 may change the exposure values in a manner that the evaluation value B corresponds to the upper limit value (EVMAX) of the evaluation value B. In the case where the brightness range of the subject does not exceed the second threshold, the evaluation control unit 160 may change the evaluation values in a manner that the evaluation value A corresponds to the target value (EVREF) of the evaluation value A. Next, in the case where the brightness range of the subject does not exceed the first threshold and the brightness range of the subject exceeds the second threshold, the exposure control unit 160 does not have to change the exposure values.

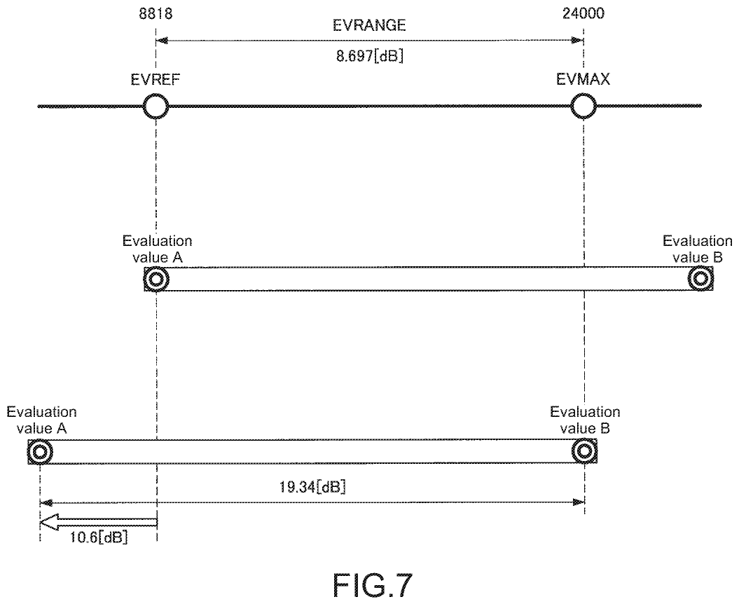

FIG. 7 is a diagram illustrating an example of the evaluation value A and the evaluation value B after controlling different exposure values. In the example illustrated in FIG. 7, it is determined that the brightness range of the subject exceeds a threshold (EVRANGE) (=8.697 [dB]), and the exposure value is changed in a manner that the evaluation value B corresponds to an upper limit value (EVMAX) (=24000). Since the exposure value is changed as described above, the evaluation value A is reduced by approximately 10.6 [dB] in comparison with the case where the exposure value is changed in a manner that the evaluation value A corresponds to a target value (EVREF) (=8818).

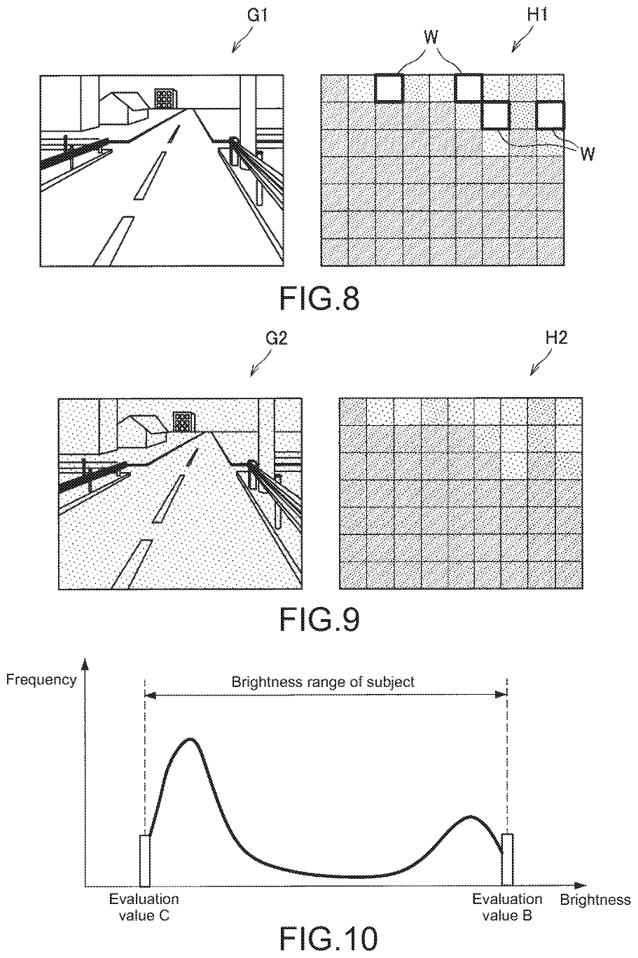

FIG. 8 and FIG. 9 are diagrams illustrating respective specific examples of brightness calculation results and pieces of imaging data corresponding to the examples illustrated in FIG. 7. FIG. 8 illustrates an image G1 that is captured after controlling the exposure value in a manner that the evaluation value A corresponds to the target value (EVREF). In addition, FIG. 8 illustrates a brightness calculation result H1 with regard to regions of the image G1. With reference to the brightness calculation result H1, it is understood that saturation regions W have appeared.

On the other hand, FIG. 9 illustrates an image G2 that is captured after controlling the exposure value in a manner that the evaluation value B corresponds to the upper limit value (EVMAX). In addition, FIG. 9 illustrates a brightness calculation result H2 with regard to regions of the image G2. With reference to the image G2 illustrated in FIG. 9, it is understood that the image G2 is darker as a whole in comparison with the image G1 illustrated in FIG. 8. However, with reference to the brightness calculation result H2 illustrated in FIG. 9, it is understood that no saturation region has appeared in contrast to the brightness calculation result H1 illustrated in FIG. 8.

The details of functions of the exposure control unit 160 have been described above.

### 1.2.4. Details of Functions of Other Configurations

Next, with reference to FIG. 2 again, details of functions of other configurations included in the information processing device 10 will be described. At least any one of imaging data captured by the image capturing unit 20-1 or imaging data captured by the image capturing unit 20-2 is input to the signal processing unit 140. Here, a case where the imaging data captured by the image capturing unit 20-1 is input to the signal processing unit 140 is considered. In addition, various kinds of information detected by the detection unit 120 (such as calculation results of brightness in respective regions or information indicating a distance to a subject) are input to the signal processing unit 140.

The signal processing unit 140 performs various kinds of signal processes on the imaging data captured by the image capturing unit 20-1. For example, the signal processes may include various kinds of signal processes such as clamping, defect correction, a demosaicing process, white balance adjustment, contour correction, gamma correction, YC conversion, color difference correction, and noise reduction. Note that, after the exposure control unit 160 controls the exposure value, various kinds of signal processes are performed on imaging data captured by the image capturing unit 20-1 after controlling the exposure value.

The image processing unit 150 performs various kinds of image processes (such as a recognition process and the like) on the imaging data input from the signal processing unit 140. Here, a case where the operation body (such as a hand) is recognized on the basis of the imaging data input from the signal processing unit 140 will be mainly considered. Note that, after the exposure control unit 160 controls the exposure value, various kinds of signal processes (such as the recognition process and the like) are performed on the imaging data input from the signal processing unit 140 after controlling the exposure value.

The display unit 30 displays an image on the basis of the imaging data input from the image processing unit 150. Note that, after the exposure control unit 160 controls the exposure value, the image is displayed on the basis of the imaging data input from the image processing unit 150 after controlling the exposure value. Accordingly, a state such as blown-out highlights or the like (saturation state) does not arise in the image displayed by the display unit 30 after the exposure control unit 160 controls the exposure value. It is considered that the image has standard brightness.

The details of the functions of the configurations included in the information processing device 10 according to the embodiment of the present disclosure have been described above.

### 1.2.5. Various Kinds of Modifications

Next, various kinds of modifications will be described. The example in which the range determination unit 130 decides that the evaluation value B is the maximum value of brightness in the detection region 231 has been described above. In addition, the example in which the range determination unit 130 decides that the evaluation value A is the average value of brightness in the predetermined region including the detection region 231 has been described above. However, brightness frequency distribution (luminance histogram) may be taken into consideration when the range determination unit 130 decides various kinds of evaluation values.

FIG. 10 is a diagram illustrating a luminance histogram in the detection region 231. With reference to FIG. 10, the range determination unit 130 decides that the evaluation value B is the maximum value of brightness that has occurred at more than a predetermined frequency. In addition, the range determination unit 130 decides that an evaluation value C is the minimum value of brightness that has occurred more than the predetermined frequency. The range determination unit 130 may decide the brightness range of the subject in a way similar to the above-described way by using the decided evaluation value B and the evaluation value C decided as a substitute for the evaluation value A.

In addition, the example in which the exposure control unit 160 changes the exposure values unconditionally in a manner that the evaluation value B corresponds to the upper limit value of the evaluation value B in the case where the brightness range of the subject exceeds the threshold has been described above. However, a case where the evaluation value A decreases too much due to the change in the exposure value after changing the exposure value, is also considered (a case where the image gets too dark after changing the exposure value, is also considered). Therefore, it is possible to set a lower limit value for the evaluation value A.

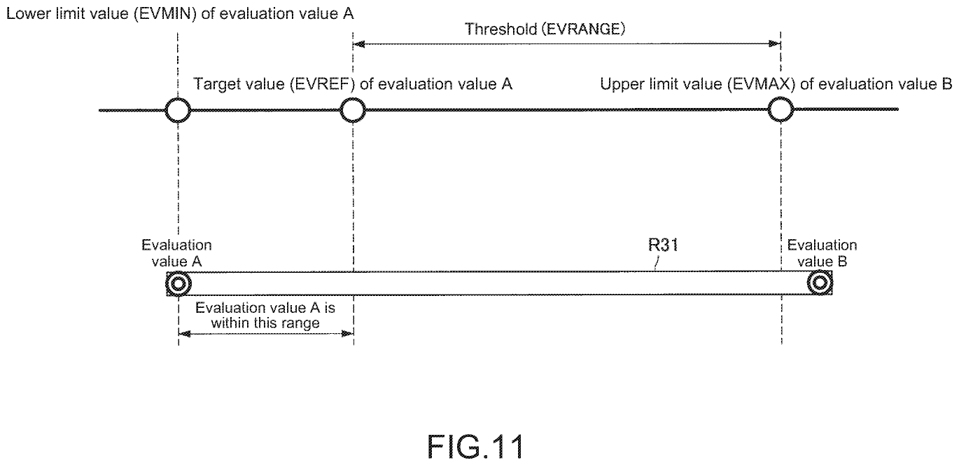

FIG. 11 is a diagram for describing an example in which the lower limit value is set for the evaluation value A. With reference to FIG. 11, a brightness range R31 of a subject calculated on the basis of the evaluation value A and the evaluation value B exceeds a threshold (EVRANGE). Therefore, according to the above-described example, the exposure control unit 160 controls the exposure value in a manner that the evaluation value B corresponds to the upper limit (EVMAX) of the evaluation value B.

However, as illustrated in FIG. 11, a case where a lower limit (EVMIN) is set for the evaluation value A is considered. In this case, the exposure control unit 160 may change the exposure value in a manner that the evaluation value A does not fall below the lower limit (EVMIN) of the evaluation value A even if the brightness range of the subject exceeds a threshold (EVRANGE). For example, as illustrated in FIG. 11, in the case where the evaluation value A falls below the lower limit value (EVMIN) of the evaluation value A if the evaluation value B corresponds to the upper limit value (EVMAX) of the evaluation value B, the exposure control unit 160 may control the exposure value in a manner that the evaluation value A corresponds to the lower limit (EVMIN) of the evaluation value A.

In addition, after changing the exposure value, the display unit 30 may display an image captured after changing the exposure value as described above. However, if the evaluation value is controlled in a manner that the evaluation value B corresponds to the upper limit value (EVMAX) of the evaluation value B, a dark image is captured after changing the exposure value. Accordingly, to improve visibility of the user, the signal processing unit 140 may perform a signal process such as the gamma correction or the gradation conversion on the image to be displayed on the display unit 30.

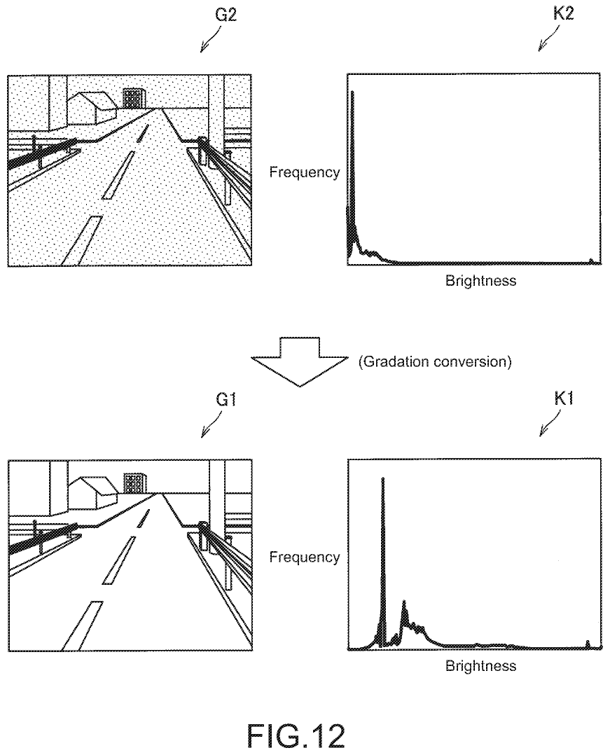

FIG. 12 is a diagram illustrating examples of images and luminance histograms before and after performing the gradation conversion. The image G2 in FIG. 12 is an example of the image captured after changing the exposure value. A luminance histogram K2 is an example of the luminance histogram of the image captured after changing the exposure value. With reference to the image G2 and the luminance histogram K2, it is understood that the image gets dark when the image is captured after changing the exposure value.

On the other hand, the image G1 in FIG. 12 is an example of the image obtained after the gradation conversion is performed on the image G2. A luminance histogram K1 is an example of the luminance histogram of the image obtained after the gradation conversion is performed on the image G2. With reference to the image G1 and the luminance histogram K1, the image obtained after performing the gradation conversion is lighter than the image captured after changing the exposure value. Therefore, it is understood that the visibility is improved. Note that, in the case where the display unit 30 does not display the image, it is possible to input the image to the image processing unit 150 without performing the gradation conversion.

The various types of modifications have been described above.

### 1.3. Hardware Configuration Example

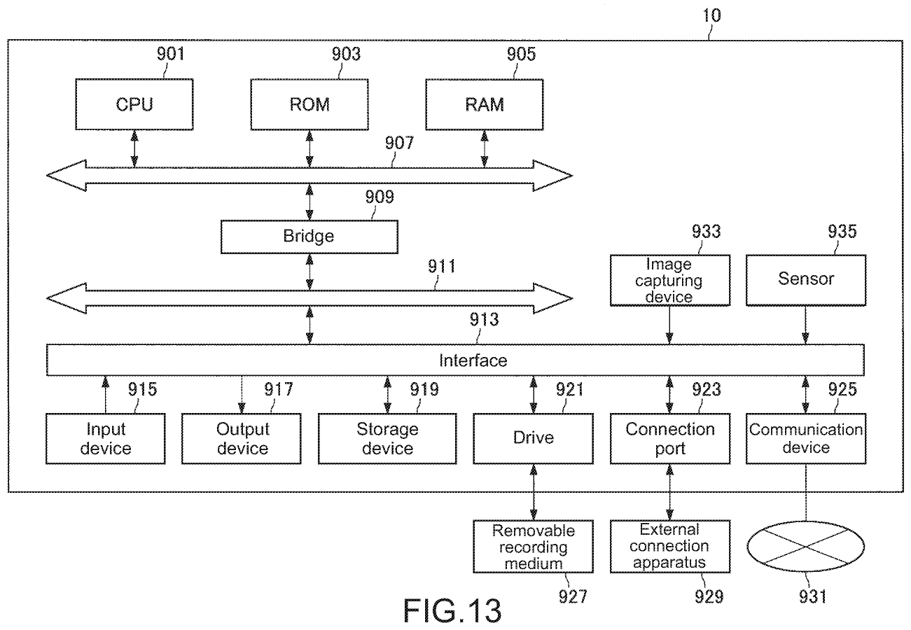

Next, with reference to FIG. 13, a hardware configuration of the information processing device 10 according to the embodiment of the present disclosure will be described. FIG. 13 is a block diagram illustrating a hardware configuration example of the information processing device 10 according to the embodiment of the present disclosure.

As illustrated in FIG. 13, the information processing device 10 includes a central processing unit (CPU) 901, read only memory (ROM) 903, and random access memory (RAM) 905. In addition, the information processing device 10 may include a host bus 907, a bridge 909, an external bus 911, an interface 913, an input device 915, an output device 917, a storage device 919, a drive 921, a connection port 923, and a communication device 925. Moreover, the information processing device 10 may include an image capturing device 933, and a sensor 935, as necessary. The information processing device 10 may include a processing circuit such as a digital signal processor (DSP) or an application specific integrated circuit (ASIC), in place of or in addition to the CPU 901.

The CPU 901 functions as an arithmetic processing device and a control device, and controls the overall operation or a part of the operation of the information processing device 10 in accordance with various kinds of programs recorded on the ROM 903, the RAM 905, the storage device 919, or a removable recording medium 927. The ROM 903 stores programs, operation parameters, and the like used by the CPU 901. The RAM 905 temporarily stores programs used when the CPU 901 operates, and parameters and the like that change as appropriate when executing such programs. The CPU 901, the ROM 903, and the RAM 905 are connected to each other via the host bus 907 including an internal bus such as a CPU bus or the like. In addition, the host bus 907 is connected to the external bus 911 such as a peripheral component interconnect/interface (PCI) bus via the bridge 909.

The input device 915 is a device operated by a user such as a button. The input device 915 may include a mouse, a keyboard, a touchscreen, a switch, a lever, or the like. In addition, the input device 915 may include a microphone that detects voice of users. For example, the input device 915 may be a remote control using infrared light or other radio waves, or may be an external connection apparatus 929 such as a mobile phone that supports operation of the information processing device 10. The input device 915 includes an input control circuit that generates input signals on the basis of information which is input by a user to output the generated input signals to the CPU 901. The user inputs various kinds of data and indicates processing operation to the information processing device 10 by operating the input device 915. In addition, the image capturing device 933 (to be described later) may function as the input device by capturing an image of movement of hands of the user or capturing a finger of the user. In this case, a pointing position may be decided in accordance with the movement of the hand or the direction of the finger.

The output device 917 includes a device capable of visually or audibly reporting acquired information to the user. For example, the output device 917 may be a display device such as a liquid crystal display (LCD) or an organic electro-luminescence display (OELD), or a sound output device such as a speaker or headphones. In addition, the output device 917 may include a plasma display panel (PDP), a projector, a hologram device, a printer device, and the like. The output device 917 outputs a result obtained through a process performed by the information processing device 10, in the form of video such as a text or an image, or in the form of sounds such as voice or audio sounds. In addition, the output device 917 may include a light or the like to light the surroundings.

The storage device 919 is a device for data storage that is an example of a storage unit of the information processing device 10. The storage device 919 includes, for example, a magnetic storage device such as a hard disk drive (HDD), a semiconductor storage device, an optical storage device, a magneto-optical storage device, or the like. The storage device 919 stores programs and various kinds of data executed by the CPU 901, various kinds of data acquired from an outside, and the like.

The drive 921 is a reader/writer for the removable recording medium 927 such as a magnetic disk, an optical disc, a magneto-optical disk, or semiconductor memory, and the drive 921 is built in or externally attached to the information processing device 10. The drive 921 reads out information recorded on the mounted removable recording medium 927, and outputs the information to the RAM 905. In addition, the drive 921 writes the record into the mounted removable recording medium 927.

The connection port 923 is a port used for directly connecting the apparatus to the information processing device 10. The connection port 923 may be a universal serial bus (USB) port, an IEEE1394 port, and a small computer system interface (SCSI) port, or the like, for example. In addition, the connection port 923 may be an RS-232C port, an optical audio terminal, a high-definition multimedia interface (HDMI) (registered trademark) port, or the like. The connection between the external connection apparatus 929 and the connection port 923 makes it possible to exchange various kinds of data between the information processing device 10 and the external connection apparatus 929.

The communication device 925 is a communication interface including, for example, a communication device or the like for connection to a network 931. The communication device 925 may be, for example, a communication card for a wired or wireless local area network (LAN), Bluetooth (registered trademark), or a wireless USB (WUSB). Alternatively, the communication device 925 may also be, for example, a router for optical communication, a router for asymmetric digital subscriber line (ADSL), or a modem for various kinds of communication. For example, the communication device 925 transmits and receives signals and the like on the Internet or to and from another communication apparatus by using a predetermined protocol such as TCP/IP. In addition, the communication network 931 to which the communication device 925 connects is a network established through wired or wireless connection. The network 931 is, for example, the Internet, a home LAN, infrared communication, radio wave communication, satellite communication, or the like.

The image capturing device 933 is a device that captures an image of a real space by using an image sensor such as a charge coupled device (CCD) or a complementary metal oxide semiconductor (CMOS), and various kinds of members such as a lens for controlling image formation of a subject image onto the image sensor, and generates the captured image, for example. The image capturing device 933 may capture a still image or a moving image.

The sensor 935 is various kinds of sensors such as a ranging sensor, an acceleration sensor, a gyro sensor, a geomagnetic sensor, a vibration sensor, an optical sensor, or a sound sensor, for example. The sensor 935 acquires information regarding a state of the information processing device 10 such as a posture of a housing of the information processing device 10, and information regarding an environment surrounding the information processing device 10 such as luminous intensity and noise around the information processing device 10, for example. In addition, the sensor 935 may include a global positioning system (GPS) sensor that receives GPS signals to measure latitude, longitude, and altitude of the device.

### 2. Conclusion

As described above, according to the embodiment of the present disclosure, there is provided the information processing device 10 including the determination unit 110 and the exposure control unit 160. The determination unit 110 determines a range of brightness on the basis of imaging data captured by the plurality of image capturing units. The exposure control unit 160 controls exposure values of the plurality of image capturing units on the basis of the range of brightness. When the information processing device 10 is used, it is possible to appropriately control brightness of an image by using a simpler structure.

More specifically, according to the embodiment, a plurality of image sensors with different exposure values or a circuit for combining images captured by the respective image sensors is not necessary. It is possible to control an exposure value in a manner that a state such as blown-out highlights or the like (saturation) does not arise in an image in accordance with a brightness range of the image and in a manner that the image has standard brightness.

The suitable embodiment(s) of the present disclosure has/have been described above with reference to the accompanying drawings, whilst the present disclosure is not limited to the above examples. It is apparent that a person skilled in the art can find various alterations and modifications within the scope of the technical idea described in the appended claims, and it should be understood that they will naturally come under the technical scope of the present disclosure.

For example, a time slot and a place in which the information processing device 10 is used are not specifically limited. For example, the information processing device 10 may be applied to a camera with a night mode. For example, when the information processing device 10 is applied to the camera with the night mode, it is possible to suppress a possibility that saturation occurs due to a point light source such as a light and a possibility that a dark region includes too much noise due to gain in the case where an image is captured outside at night.

In addition, the example in which the exposure value is controlled in a manner that the evaluation value A corresponds to the target value in the case where the brightness range does not exceed the threshold, and the example in which the exposure value is controlled in a manner that the evaluation value B corresponds to the upper limit value in the case where the brightness range exceeds the threshold, have been described above. However, it is also possible to alternately output pieces of the imaging data to the image processing unit 150 in units of frame in accordance with the plurality of exposure values. In this case, the image processing unit 150 may perform a recognition process for each of the exposure values, and may expand the dynamic range by integrating results of the respective recognition processes.

In addition, the effects described in this specification are merely illustrative and demonstrative, and not limitative. In other words, the technology according to the present disclosure can exhibit other effects that are evident to those skilled in the art along with or instead of the effects based on this specification.

Note that, the present technology is also configured as below.

(1)

An information processing device including:

a determination unit that determines a range of brightness on a basis of a plurality of pieces of imaging data captured by a plurality of image capturing units; and

an exposure control unit that controls exposure values of the plurality of image capturing units on a basis of the range of brightness.

(2)

The information processing device according to (1),

in which, in a case where the range of brightness exceeds a first threshold, the exposure control unit changes the exposure values in a manner that a maximum value of brightness in a detection region detected on a basis of the plurality of pieces of imaging data corresponds to a predetermined upper limit value.

(3)

The information processing device according to (2),

in which, in a case where the range of brightness does not exceed a second threshold, the exposure control unit changes the exposure values in a manner that a representative value of brightness in a predetermined region including the detection region corresponds to a predetermined target value.

(4)

The information processing device according to (3),

in which, in a case where the range of brightness exceeds the first threshold, the exposure control unit changes the exposure values in a manner that the representative value of brightness does not fall below a predetermined lower limit value.

(5)

The information processing device according to (3) or (4),

in which the determination unit includes a range determination unit that determines the range of brightness on a basis of the maximum value and the representative value.

(6)

The information processing device according to (5),

in which the range determination unit determines the range of brightness on a basis of a ratio of the maximum value to the representative value.

(7)

The information processing device according to (5) or (6),

in which the range determination unit decides the maximum value of brightness that has occurred in the detection region at more than a predetermined frequency.

(8)

The information processing device according to any one of (5) to (7),

in which the range determination unit calculates an average value of brightness in the predetermined region as the representative value.

(9)

The information processing device according to any one of (5) to (7),

in which the range determination unit calculates a minimum value of brightness in the predetermined region as the representative value.

(10)

The information processing device according to (9),

in which the range determination unit decides the minimum value of brightness that has occurred in the predetermined region at more than a predetermined frequency.

(11)

The information processing device according to any one of (3) to (10),

in which the determination unit includes a detection unit that calculates brightness in respective regions of the plurality of pieces of imaging data and detects the detection region on a basis of the brightness in the respective regions of the plurality of pieces of imaging data.

(12)

The information processing device according to (11),

in which the detection unit calculates a difference value of brightness in corresponding regions in the plurality of pieces of imaging data, and detects the detection region on a basis of a relation between the difference values and a predetermined reference value.

(13)

The information processing device according to (12),

in which, as the detection region, the detection unit detects a region including a region having the difference value that exceeds the predetermined reference value.

(14)

The information processing device according to (12),

in which, as the detection region, the detection unit detects a region including a region having the difference value that does not exceed the predetermined reference value.

(15)

The information processing device according to any one of (11) to (14),

in which, as the brightness of the respective regions of the plurality of pieces of imaging data, the detection unit calculates an integrated value or an average value of respective regions of brightness of the plurality of pieces of imaging data.

(16)

The information processing device according to any one of (1) to (15), including

an image processing unit that performs a predetermined recognition process on a basis of at least any one of a plurality of pieces of imaging data captured by the plurality of image capturing units after controlling the exposure values.

(17)

An image capturing device including:

a plurality of image capturing units;

a determination unit that determines a range of brightness on a basis of a plurality of pieces of imaging data captured by the plurality of image capturing units; and

an exposure control unit that controls exposure values of the plurality of image capturing units on a basis of the range of brightness.

(18)

An electronic apparatus including:

a determination unit that determines a range of brightness on a basis of a plurality of pieces of imaging data captured by a plurality of image capturing units;

an exposure control unit that controls exposure values of the plurality of image capturing units on a basis of the range of brightness; and

a display unit that performs display based on at least any one of a plurality of pieces of imaging data captured by the plurality of image capturing units after controlling the exposure values.

### REFERENCE SIGNS LIST

10 information processing device
110 determination unit
120 detection unit
130 range determination unit
140 signal processing unit
150 image processing unit
160 exposure control unit
20 image capturing unit
210 imaging data
211 far-distant object
213 near-distant object
220 calculation result
230 difference image
231 detection region
30 display unit

1. An information processing device comprising:
a determination unit that determines a range of brightness on a basis of a plurality of pieces of imaging data captured by a plurality of image capturing units; and
an exposure control unit that controls exposure values of the plurality of image capturing units on a basis of the range of brightness.

2. The information processing device according to claim 1,
wherein, in a case where the range of brightness exceeds a first threshold, the exposure control unit changes the exposure values in a manner that a maximum value of brightness in a detection region detected on a basis of the plurality of pieces of imaging data corresponds to a predetermined upper limit value.

3. The information processing device according to claim 2,
wherein, in a case where the range of brightness does not exceed a second threshold, the exposure control unit changes the exposure values in a manner that a representative value of brightness in a predetermined region including the detection region corresponds to a predetermined target value.

4. The information processing device according to claim 3,
wherein, in a case where the range of brightness exceeds the first threshold, the exposure control unit changes the exposure values in a manner that the representative value of brightness does not fall below a predetermined lower limit value.

5. The information processing device according to claim 3,
wherein the determination unit includes a range determination unit that determines the range of brightness on a basis of the maximum value and the representative value.

6. The information processing device according to claim 5,
wherein the range determination unit determines the range of brightness on a basis of a ratio of the maximum value to the representative value.

7. The information processing device according to claim 5,
wherein the range determination unit decides the maximum value of brightness that has occurred in the detection region at more than a predetermined frequency.

8. The information processing device according to claim 5,
wherein the range determination unit calculates an average value of brightness in the predetermined region as the representative value.

9. The information processing device according to claim 5,
wherein the range determination unit calculates a minimum value of brightness in the predetermined region as the representative value.

10. The information processing device according to claim 9,
wherein the range determination unit decides the minimum value of brightness that has occurred in the predetermined region at more than a predetermined frequency.

11. The information processing device according to claim 3,
wherein the determination unit includes a detection unit that calculates brightness in respective regions of the plurality of pieces of imaging data and detects the detection region on a basis of the brightness in the respective regions of the plurality of pieces of imaging data.

12. The information processing device according to claim 11,
wherein the detection unit calculates a difference value of brightness in corresponding regions in the plurality of pieces of imaging data, and detects the detection region on a basis of a relation between the difference values and a predetermined reference value.

13. The information processing device according to claim 12,
wherein, as the detection region, the detection unit detects a region including a region having the difference value that exceeds the predetermined reference value.

14. The information processing device according to claim 12,
wherein, as the detection region, the detection unit detects a region including a region having the difference value that does not exceed the predetermined reference value.

15. The information processing device according to claim 11,
wherein, as the brightness of the respective regions of the plurality of pieces of imaging data, the detection unit calculates an integrated value or an average value of respective regions of brightness of the plurality of pieces of imaging data.

16. The information processing device according to claim 1, comprising
an image processing unit that performs a predetermined recognition process on a basis of at least any one of a plurality of pieces of imaging data captured by the plurality of image capturing units after controlling the exposure values.

17. An image capturing device comprising:
a plurality of image capturing units;
a determination unit that determines a range of brightness on a basis of a plurality of pieces of imaging data captured by the plurality of image capturing units; and
an exposure control unit that controls exposure values of the plurality of image capturing units on a basis of the range of brightness.

18. An electronic apparatus comprising:
a determination unit that determines a range of brightness on a basis of a plurality of pieces of imaging data captured by a plurality of image capturing units;
an exposure control unit that controls exposure values of the plurality of image capturing units on a basis of the range of brightness; and
a display unit that performs display based on at least any one of a plurality of pieces of imaging data captured by the plurality of image capturing units after controlling the exposure values.
